(19) United States
(12) Patent Application Publication
(10) Pub. No.: US 2008/0012831 A1
(43) Pub. Date: Jan. 17, 2008

(54) Laptop Computer System Having Extended Touch-Pad Functionality and a Method For Producing the Laptop Computer System Having Extended Touch-Pad Functionality

(75) Inventors: Amanda Bauman, Austin, TX (US); Brian Bauman, Austin, TX (US); Michael P. Carlson, Austin, TX (US); Jennifer A. Fogell, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/457,908

(22) Filed: Jul. 17, 2006

(51) Int. Cl. G06F 3/041

(52) U.S. Cl. 345/173

(57) ABSTRACT

A laptop computer system having extended touch-pad functionality and a method for producing the laptop computer system having extended touch-pad functionality are provided. The laptop computer system includes a touch-pad having a first portion parallel and adjacent to a second portion. The touch-pad is configured for at least one of, (i) the first portion configured to control a cursor movement and placement functions on a first region of the first display and the second portion configured to control a cursor movement and placement functions on a second region of the first display. Secondly, (ii) the first portion configured to control the cursor movement and placement functions on the first display and the second portion configured to control the cursor movement and placement functions on a second display connected to the laptop computer system.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to computer systems, and more particularly, to a configurable touch-pad for a laptop computer system.

2. Description of Background

Laptop computers are designed in a variety of styles; for example, some laptops have a compact disk drive (CD drive) while others have only a floppy disk drive or a combination of both.

Many laptop computers include a touch-pad device. Many users report liking the touch-pad, and many users report they use the touch-pad to control the system pointer. Other users do not like the touch-pad because of various reasons. A common reason rendered for disliking the touch-pad is that the user continuously bumps into the touch-pad and often turns the touch-pad off. Yet, the touch-pad is a very valuable laptop tool that is preferred by more people than not. To increase the value of the touch-pad, more control is necessary over the functions that the touch-pad can provide. Furthermore, with the increasing size and quality of computer monitors, as well as multi-monitor video cards, the touch-pad available on many laptops have more uses than ever. The touch-pad is growing so much in interest that many laptop users are switching to touch-pad usage instead of using a traditional mouse.

Thus, there is a need for a system and a method that extends the functionality of the touch-pad to allow the touch-pad to be assignable to different regions of the same display or to different displays on a multi-display computer system.

### SUMMARY OF THE INVENTION

The shortcomings of the prior art are overcome and additional advantages are provided through the provision of a laptop computer system having extended touch-pad functionality, comprising: a base housing a microprocessor, the microprocessor being communicatively coupled to a system storage, a video controller and a mass storage via a bus for communicating, the system storage, the video controller and the mass storage also being housed in the base; a keyboard having a plurality of keys, the keys communicatively coupled to the microprocessor via the bus, the keyboard being embedded in the base; a first display connected to the base via a first hinge and a second hinge such that the first display is moveable between a closed position and an open position, the first display communicatively coupled to the microprocessor via the video controller which drives the display; and a touch-pad having a first portion parallel and adjacent to a second portion, the touch-pad configured for at least one of, (i) the first portion configured to control a cursor movement and placement functions on a first region of the first display and the second portion configured to control a cursor movement and placement functions on a second region of the first display, and (ii) the first portion configured to control the cursor movement and placement functions on the first display and the second portion configured to control the cursor movement and placement functions on a second display connected to the laptop computer system.

The shortcomings of the prior art are overcome and additional advantages are provided through the provision of a method for producing a laptop computer system having extended touch-pad functionality, comprising: producing a base housing a microprocessor, the microprocessor being communicatively coupled to a system storage, a video controller and a mass storage via a bus for communicating, the system storage, the video controller and the mass storage also being housed in the base; embedding a keyboard having a plurality of keys in the base, the keys being communicatively coupled to the microprocessor; connecting a first display to the base via a first hinge and a second hinge, the first display being communicatively coupled to the microprocessor via the video controller which drives the display; and configuring a touch-pad having a first portion parallel and adjacent to a second portion, the touch-pad configured for at least one of, (i) the first portion configured to control a cursor movement and placement functions on a first region of the first display and the second portion configured to control a cursor movement and placement functions on a second region of the first display, and (ii) the first portion configured to control the cursor movement and placement functions on the first display and the second portion configured to control the cursor movement and placement functions on a second display connected to the laptop computer system.

The shortcomings of the prior art are overcome and additional advantages are provided through the provision of a system having extended touch-pad functionality. The system includes a base housing a microprocessor. A keyboard is communicatively coupled via a bus to the microprocessor. The system further includes a first display for displaying information. The first display is communicatively coupled to the microprocessor via the bus. The system further includes a touch-pad having a first portion and a second portion. The touch-pad is communicatively coupled to the microprocessor via the bus. The touch-pad is configured for at least one of, (i) the first portion configured to control a cursor movement and placement functions on a first region of the first display and the second portion configured to control a cursor movement and placement functions on a second region of the first display, and (ii) the first portion configured to control the cursor movement and placement functions on the first display and the second portion configured to control the cursor movement and placement functions on a second display connected via the bus to the system.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a laptop computer system and a method for producing the laptop computer system that extends the functionality of the touch-pad to allow the touch-pad to be assignable to different regions of the same display or to different displays on a multi-display computer system.

### BRIEF DESCRIPTION OF THE DRAWING

The subject matter, which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a laptop computer system;

FIG. 2 illustrates one example of an alternative embodiment of the laptop computer system shown in FIG. 1; and

FIG. 3 illustrates one example of a block diagram of an alternative embodiment of the disclosed invention.

The detailed description explains the preferred embodiments of the invention, together with advantages and features, by way of example with reference to the drawings.

### DETAILED DESCRIPTION OF THE INVENTION

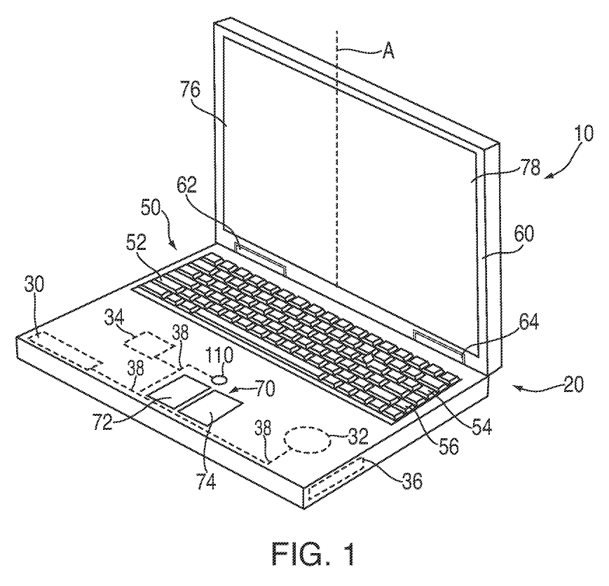

Referring to FIG. 1, an exemplary embodiment of a laptop computer system 10, is shown. The laptop computer system 10 includes a base 20, a keyboard 50, a first display 60, a touch-pad 70 and a mouse stick 110.

The base 20 houses a microprocessor 30 among other components. The microprocessor 30 is the integrated circuit that contains the entire central processing unit of the laptop computer system 10. The microprocessor 30 is communicatively coupled to other components housed in the base 20. Those other components include a system storage 32, a video controller 34, and a mass storage 36, which are all communicatively coupled to the microprocessor 30 via a bus 38 for communicating.

The keyboard 50 is embedded in the base 20 and includes a plurality of keys 52, 54 and 56 that are used for entering data. The keys 52, 54 and 56, like the previous mentioned components are also communicatively coupled to the microprocessor 30 via the bus 38.

The first display 60 is connected to the base 20 via a first hinge 62 and a second hinge 64 such that the display 60 is moveable between a closed position where it is not viewable, and an open position where it is viewable, as shown. The first display 60 is communicatively coupled to the video controller 34, which in turn is communicatively coupled to the microprocessor 30. In operation, a signal is transmitted from the microprocessor 30 by way of the bus 38 to the video controller 34, which in turn drives the first display 60.

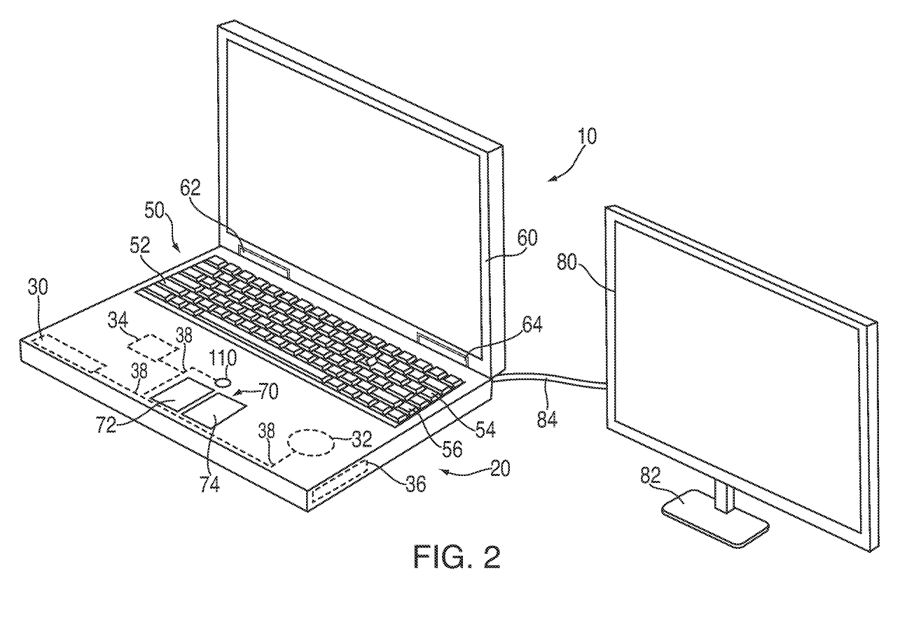

The touch-pad 70 includes a first portion 72 that is parallel and adjacent to a second portion 74. The touch-pad 72 is embedded in the base 20 and is communicatively coupled to the microprocessor 30 via the bus 38. The touch-pad 72 is distinguished by being configured for at least one of the following, (i) the first portion 72 being configured to control the cursor movement and placement functions on a first region 76 of the first display 60, and the second portion 74 being configured to control the cursor movement and placement functions on a second region 78 of the first display 60, as shown the regions 76 and 78 are separated by vertical axis A. Although the regions 76 and 78 are shown as being separated by vertical axis A, it should be well known by one skilled in the art that axis A may alternatively be horizontal or diagonal and the regions 76 and 78 configured to correspond to the horizontal or diagonal axis arrangement. Secondly, (ii) the first portion 72 is configured to control the cursor movement and placement functions on the first display 60 and the second portion 74 is configured to control the cursor movement and placement functions on a second display 80 connected to the laptop computer system 10, as shown in FIG. 2. In an alternate embodiment, first and second portions 72 and 74 are separate touch-pads rather than portions of the same touch-pad.

The second display 80 includes a support stand 82 for positioning the second display 80 on a surface. The second display 80 further includes a conductive cable 84 used for communicatively coupling the second display 80 to the laptop computer system 10.

Located adjacent to the touch-pad 70 is the mouse stick 110. The mouse stick 110 is embedded in the base 20 and is communicatively coupled to the microprocessor 30 via the bus 38. It should be known by one skilled in the art that the mouse stick 110 might be located in a different area. For example, it is not uncommon for mouse sticks 110 to be located in between the keys 52, 54 and 56 of a keyboard 50.

Referring to FIGS. 1 and 2, a method for producing a laptop computer system 10 in accordance with exemplary embodiments will now be explained.

At a first step, the base 20 is produced such that the base 20 houses a microprocessor 30 among other components. The microprocessor 30 is communicatively coupled to a system storage 32, a video controller 34 and a mass storage 36 via a bus 38 for communicating. The system storage 32, the video controller 34 and the mass storage 36 are also housed within the base 20.

At a second step, a keyboard 50 having a plurality of keys 52, 54 and 56 is embedded in the base 20. The keys 52, 54 and 56 are communicatively coupled to the microprocessor 30 via the bus 38.

At a third step, a first display 60 is connected to the base 20 via a first hinge 62 and a second hinge 64 such that the first display 60 is moveable between a closed position where it is not viewable and an open position where it is viewable. The first display 60 is communicatively coupled to the video controller 34, which in turn is communicatively coupled to the microprocessor 30. In operation, a signal is transmitted from the microprocessor 30 by way of the bus 38 to the video controller 34, which in turn drives the first display 60.

At a fourth step, a touch-pad 70 having a first portion 72 parallel and adjacent to a second portion 74 is configured. The touch-pad 70 is configured for at least one of, (i) the first portion 72 is configured to control a cursor movement and placement functions on a first region 76 of the first display 60 and the second portion 74 is configured to control a cursor movement and placement functions on a second region 78 of the first display 60. Secondly, (ii) the first portion 72 is configured to control the cursor movement and placement functions on the first display 60 and the second portion 74 is configured to control the cursor movement and placement functions on a second display 80 that is connected to the laptop computer system 10. The touch-pad 70 is embedded in the base 20 and is communicatively coupled to the microprocessor 30. The second display 80 includes a support stand 82 for positioning the second display 80 on a surface. The second display 80 further includes a conductive cable 84 used for communicatively coupling the second display 80 to the laptop computer system 10.

At a fifth step, a mouse stick 110 is embedded in the base 20. The mouse stick 110 is communicatively coupled to the microprocessor 30 via the bus 38.

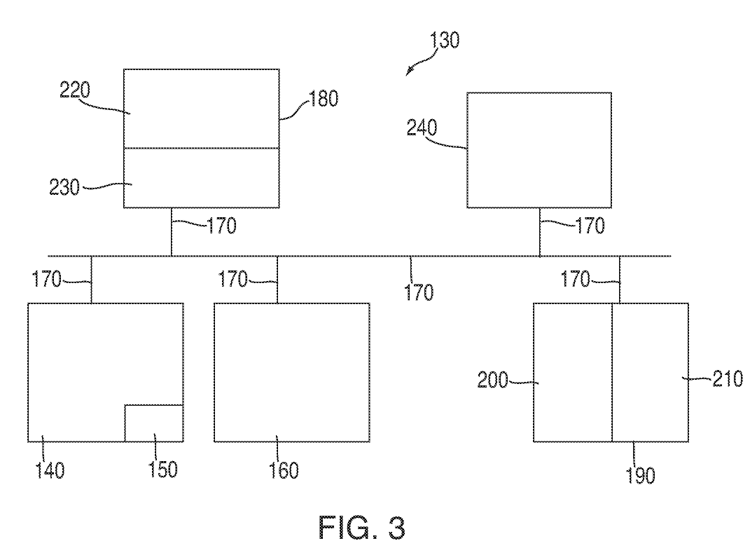

Referring to FIG. 3, a system 130 having extended touch-pad functionality is shown, in accordance with another alternative embodiment of the disclosed invention. The system 130 includes a base 140 that houses a microprocessor 150. A keyboard 160 is communicatively coupled via a bus 170 to the microprocessor 150. A first display 180 for displaying information is communicatively coupled to the microprocessor 150 via the bus 170. The system 130 further includes a touch-pad 190 having a first portion 200 and a second portion 210. The touch-pad 190 is communicatively coupled to the microprocessor 150 via the bus 170. The touch-pad 190 is configured for at least one of, (i) the first portion 200 being configured to control a cursor movement and placement functions on a first region 220 of the first display 180 and the second portion 210 being configured to control a cursor movement and placement functions on a second region 230 of the first display 180. Secondly, (ii) the first portion 200 is configured to control the cursor movement and placement functions on the first display 180 and the second portion 210 configured to control the cursor movement and placement functions on a second display 240 connected via the bus 170 to the system 130. As illustrated, this embodiment utilizes an external touch-pad 190 with the system 130 that includes various linked components working together.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A laptop computer system having extended touch-pad functionality, comprising:
a base housing a microprocessor, the microprocessor being communicatively coupled to a system storage, a video controller and a mass storage via a bus for communicating, the system storage, the video controller and the mass storage also being housed in the base;
a keyboard having a plurality of keys, the keys communicatively coupled to the microprocessor via the bus, the keyboard being embedded in the base;
a first display connected to the base via a first hinge and a second hinge such that the first display is moveable between a closed position and an open position, the first display communicatively coupled to the microprocessor via the video controller which drives the display; and
a touch-pad having a first portion parallel and adjacent to a second portion, the touch-pad configured for at least one of, (i) the first portion configured to control a cursor movement and placement functions on a first region of the first display and the second portion configured to control a cursor movement and placement functions on a second region of the first display, and (ii) the first portion configured to control the cursor movement and placement functions on the first display and the second portion configured to control the cursor movement and placement functions on a second display connected to the laptop computer system.

2. The system of claim 1, wherein the touch pad is embedded in the base and communicatively coupled to the microprocessor via the bus.

3. The system of claim 2, wherein the second display includes a support stand for positioning the second display.

4. The system of claim 3, wherein the second display further includes a conductive cable for communicatively coupling the second display to the laptop computer system.

5. The system of claim 4, further comprising a mouse stick embedded in the base, the mouse stick being communicatively coupled to the microprocessor via the bus.

7. A method for producing a laptop computer system having extended touch-pad functionality, comprising:
producing a base housing a microprocessor, the microprocessor being communicatively coupled to a system storage, a video controller and a mass storage via a bus for communicating, the system storage, the video controller and the mass storage also being housed in the base;
embedding a keyboard having a plurality of keys in the base, the keys being communicatively coupled to the microprocessor via the bus;
connecting a first display to the base via a first hinge and a second hinge, the first display being communicatively coupled to the microprocessor via the video controller which drives the display; and
configuring a touch-pad having a first portion parallel and adjacent to a second portion, the touch-pad configured for at least one of, (i) the first portion configured to control a cursor movement and placement functions on a first region of the first display and the second portion configured to control a cursor movement and placement functions on a second region of the first display, and (ii) the first portion configured to control the cursor movement and placement functions on the first display and the second portion configured to control the cursor movement and placement functions on a second display connected to the laptop computer system.

8. The method of claim 7, wherein the touch pad is embedded in the base and communicatively coupled to the microprocessor via the bus.

9. The method of claim 8, wherein the second display includes a support stand for positioning the second display.

10. The method of claim 9, wherein the second display further includes a conductive cable for communicatively coupling the second display to the laptop computer system.

11. The method of claim 10, further comprising:
embedding a mouse stick in the base, the mouse stick being communicatively coupled to the microprocessor via the bus.

12. A system having extended touch-pad functionality, comprising:
a base housing a microprocessor;
a keyboard communicatively coupled via a bus to the microprocessor;
a first display for displaying information, the first display communicatively coupled to the microprocessor via the bus;
a touch-pad having a first portion and a second portion, the touch-pad communicatively coupled to the microprocessor via the bus, the touch-pad configured for at least one of, (i) the first portion configured to control a cursor movement and placement functions on a first region of the first display and the second portion configured to control a cursor movement and placement functions on a second region of the first display, and (ii) the first portion configured to control the cursor movement and placement functions on the first display and the second portion configured to control the cursor movement and placement functions on a second display connected via the bus to the system.
